(19) United States
(12) Patent Application Publication
(10) Pub. No.: US 2002/0196204 A1
(43) Pub. Date: Dec. 26, 2002

(54) Retail customer and product purchase divider with interactive retail transaction functions

(76) Inventor: Steven Michael Matthew Senn, Seatle, WA (US)

Correspondence Address: Steven M. Senn, 5208 - 122 Pl. S.E., Everett, WA, 98208, US

(21) Appl. No.: 09/888,554

(22) Filed: Jun. 26, 2001

(51) Int. Cl. G09G 3/00

(52) U.S. Cl. 345/30

(57) ABSTRACT

Supermarket customer and product purchase checkout divider with one or more electronic interactive retail transaction functions including a point of purchase system comprising of hardware components and program menu tasks including interactive audio or video displayed on an interactive menu driven touch screen display offering a method for dispensing and redeeming electronic manufacturers coupons, receiving or imputing information or data, donating to charities, and incorporating a bar code scanning device, checkout functions, card reading device, weight product scale and checkout placement system that exchanges data with a divider system management computer by a wireless method that interacts with outside communications and stores data base and register computer to complete a transaction and customer receipt.

### BACKGROUND OF THE INVENTION

Presently at supermarkets a plastic unit that sometimes has some advertising on it is used to divide customer check out placement and products purchased at the point of purchase (POP) counter from other customers. These dividers presently come in different shapes and sizes. The following invention improves the divider into a combination customer and product divider with interactive retail transaction functions. The customer can use the divider to find information about the store, read product and store updates, secure individual electronic coupons, donate to a charity of choice, self bar code scan products, enter weight products, enter bank and store cards and help complete the check out function. The divider will not be limited performing one but a number of customer retail transaction functions or tasks. Present supermarket POP systems are very expensive and often require a capital expenditure and complete register system reconfiguration. Also if a customer wants to access all of the retail tasks the transaction divider offers they would have to perform them individually taking more time. To remedy this problem, which prior art fails to address fully, the transaction divider can offer a customer several retail tasks in one system. Supermarkets will be able to add the divider system to their existing purchasing system making the up grade in technology and service affordable. The transaction divider will help expedite the customers experience at the supermarket and allow a supermarket to expand their technology in a POP system for a reasonable cost. The supermarket will also benefit by increased customer satisfaction, advertising perks, more customer transaction options, less labor cost, data tracking, low entry and expansion cost. Also the supermarket would be able to add this system to their existing POP checkout and register system for much less cost than purchasing an entire new system.

The supermarket customers are presently using existing plastic non-mechanical dividers. The retail transaction divider will not cause the customer to stray from their normal course of shopping or the supermarkets to loose any POP counter space or require the handling of an additional check out system device. Point of purchase counter space is very valuable and the transaction divider will be used in existing space that is now taken up by the present plastic product purchase dividers. Other similar prior art shows devices that require new POP check out counter space and, or additional handling of a device by a customer or store clerk. The customer and the clerk already handle the present non-mechanical plastic divider and it already occupies POP check out counter space. The transaction divider is an improvement over existing plastic dividers and prior art by existing in, and improving existing space and being covenant to the users.

The transaction divider will be an improvement over prior devices and methods for the store and customers by catering to speed, available retail options, customer feedback, purchase tracking, updates, information and customers desire for high technology based retail devices. Coupon advertising and product sales can also be accessed by way of communications and the divider system computer. Transaction data can be seen in whole or part down to an individual store or even an individual transaction divider because of an assigned internal identification serial number. Prior art displayed methods of electronic coupon exchange but required additional devices aside from what the customer and checker are using. The transaction divider will improve the present method of electronic coupon tracking, solve a problem of paper coupons and not require additional POP checkout counter key space. Charity donations can be tracked to the store, date and individual divider in the same way as coupons. This will be a great benefit to the charities that want put funds back into the communities of origin.

The divider will be in constant use at the POP making it a high-level data-gathering device as well as a transaction divider. Through the transaction dividers internal serial number that is transmitted with every data exchange the divider data can be accessed swiftly and sorted to track transactions, advertising, contributions, customer inquiry and other communications.

Prior patents do not address the use of the transaction divider or any supermarket customer product purchase divider being used that is automated. Prior art has outlined patents that attempt to create electric coupon systems, retail charity donation systems, self-product scanning systems, point of purchase systems and self-check out systems. Prior art address one or a few of these devices and methods but fall short of these tasks that the transaction divider will perform in one device and system. The transaction divider is a unique improvement by merging automation and interaction to the product divider. The present non-mechanical customer and product divider is being used in existing space but does not contain automated capabilities.

The retail transaction divider, method and process will also overcome problems in these prior patents such as flexibility and cost in a retail transaction system. Supermarkets may not need or want fixed systems that are not flexible. The transaction divider and system will be added to an existing POP system. With customers becoming more technology orientated the need for a more automated POP system is necessary. The supermarkets will be able to purchase the system in phases or pieces, which would allow a store to expand its POP technology and keep current without financial hardship. The divider, method and process will save supermarkets having to upgrade their entire register and data base computer system, which is very costly.

A dividers internal serial number is transmitted with every data task. The divider system computer in turn communicates with every divider by addressing the individual dividers internal serial number. With the serial number a central geographical location can track any part of a transaction. This will also be helpful in monitoring the condition of any one divider for accuracy or maintenance. The service provider company may perform system software changes and upgrades remotely. Data and programs can also be changed centrally for the supermarkets, advertising companies, manufacturers, charities and other concerns. Being able to do this combined with real time transaction access will save time and money while allowing for faster data retrieval. The tracking system is an improvement over prior art by solving the ability to track tasks and transactions through an automated purchase divider.

Electronic coupon redemption is not a standard in supermarkets as present. The divider, method and process will allow manufacturers to post discount coupons easily, receive customer use data, geography and use data, update or change coupons listed on the dividers remotely from another central location using phone, internet or satellite. Customers may easily access instant manufacturer coupons from the divider through a menu driven touch display. Customers may also access charities and make a donation that will be reflected on their receipt. The charity information may also be changed remotely. The charities can receive data on how much money was donated and at which stores the donations were made. The transaction dividers individual identification number existing with the data sent and received achieve the tracking.

Prior art has addressed POP check out methods at the supermarket but falls short of the tasks, methods and convenience offered using the transaction divider. The retail transaction divider and methods will allow the customers to pick retail function tasks from a touch screen menu. The menu and tasks will be right at the fingertips of the customer at checkout for changes or completion. The divider and this method will save time and stops for the customer by combining one or more retail tasks.

The divider and process will utilize and incorporate available electronic components, construction, materials, commands, power source, external components, divider system computer, software and technology to achieve the functional method and process. The size, shape, layout or composition will vary as to the retail tasks and functions.

The main customer interactive menu and functions will include (but not be limited to) one or more of the following: stationary or scroll advertising, store information, coupons or discounts, product updates, announcements, charity donations, self-bar code scanning, check out functions, read store cards, read debit cards, read credit cards, read smart cards, weights and scales, customer feed back and information exchange. The customer can access any one of these tasks with a keyboard or touch menu display such as the type found in palm-sized computers. As with palm size computers the transaction divider may have interactive video and audio capabilities. The dividers internal memory and software will allow it to communicate with a divider systems computer located in the store. The system computer will communicate with the dividers by a wireless method or bar code scanner. The system computer will work with the store data base computer containing product and price data and existing register system. The customer will receive a receipt showing details and totals of the transaction.

The system computer combined with the wireless communication system will be able to handle and track of the dividers being used through an internal serial code number that is attached into the transaction data exchange to and from the divider. At check out the checker can download the transaction information with the serial number being attached to the final tally and receipt. This will allow the systems computer to download the transaction data into the store POP and register system.

The customer will use the divider at the check out POP to separate their placement in line as well as the products purchased for a systemized order of check out. The retail transaction divider cannot be separated from a primary goal of a systemized order of check out. If the purchase products are to left in the cart because they were self scanned the order of customer and product check out will still be maintained. When the customer enters “check out now” function on the divider, the divider system computer working with the store data computer will calculate the transactions check order placement electronically and notify the customer when it is their turn to complete the transaction process at the physical POP register. This will also maintain the dividers use as a customer and purchased product by electronically placing the customer.

In one version (the simplest) the divider will translate the data to a bar code scanner via a liquid crystal display LCD. This divider will incorporate an LCD screen that will display product information and a bar code that will be scanned by the check out clerk. Customer input will be performed with a touch keyboard. This variation may be limited to charity donations and manufacturers electronic coupons because of the limited input keys. The customer will enter desired coupon or donation data using the keyboard. The entered data will generate a unique bar code on the LCD from the dividers memory. When the LCD bar code is scanned by the check out clerk the and data is matched with the manufacturers UPC stored in the stores database a transaction will be entered into the store register system. This tells the stores system what the bar code represents and the value. The checker then clears the divider and places it for use by the next customer and the transaction is recorded on a receipt.

Another version of the device and process will use an interactive menu and touch video screen, such as used in palm computers, for customer input and display. This version may exchange data with the store database via a wireless method. This may include, but not be limited to, infrared, radio or microwave. The dividers will exchange data with a systems computer that in turn is connected with the store database and register computer. The systems computer will govern the divider process and interact with the store database, register and communications systems. The system computer will be able to access telephone, satellite or Internet systems for data upgrade, data exchange or systems management. This customer touch display variation will be combined with a separate LCD display for bar code scanning transaction data directly into the POP bar code scanner. This variation may be used for advertising, electronic manufacturers coupons and charity donations. Incorporating a divider systems computer will allow a centralized office to remotely monitor or upgrade information and offers to the dividers. Because each divider is separate, groups or individual dividers may offer different tasks and retail offers. Because of the unique internal serial number code in each dividers memory different data can be sent or received making each divider programmable and traceable.

A customer may use the divider at the POP and throughout the store by selecting one of the retail functions. If used for self bar code scanning the customer will use the divider as they shop. With weight products the customer will use digital scales connected to a wireless data transmission system. To purchase a weight product a customer will scan a weight products store bar code tag, and then place the product on the scale, enter the scale number prompting wireless transmission of the weight to the divider system computer that will relay the totals to the transaction divider where it is displayed. The product cost and weight are entered in the system computer for pending check out.

The customer may want to enter electronic coupon discounts. This is done by entering the coupon menu and selecting the desired coupons. If the customer wants to make a donation to a charity they may enter this on the divider as well. When they are ready to check out they roll the cart onto a weight scale matt. The cart and the groceries in the store have been weighed individually and entered on the systems computer program. The products combined with the customer's cart should match (or come close) to the scanned items. This will create a system of checks and balances for the store to curtail shrinkage. If the purchased products are not bagged buy a courtesy clerk the checker can still use the weight and visual examination against the scanned data for verification. All of the product data will be relayed to the systems computer by a wireless method of radio, microwave or infrared. The customer may use cash, store card, debit card, credit card or smart card at checkout. When the card is read the data is transmitted to the system computer and relayed to the online card processing service connected with the store database. The card data is not shared with the system computer memory but is forwarded to the appropriate processing company. The card number is kept in the divider working memory until the transaction is completed and then discarded. The checker will use the divider menu and code to prompt the system and store data computer to process the purchase data into a transaction and receipt. Upon completion the store register will print a receipt and the clerk will clear and set the divider for the next customer.

Prior art on a supermarket customer and product purchase divider has not uncovered the combination of a functional divider and retail transaction device. This combination will present supermarkets with an opportunity to improve efficiency and customer service. Customers want faster service, service in one location and more purchase and savings options. It is necessary for competing supermarkets to provide their customers with the latest in transaction selection and check out technology. Because the divider retail device can be added to an existing system for less cost of a new fixed retail system, it will allow supermarkets that operate on a close margin to be competitive with larger stores. Also their original manual check out system will be intact to be used or as a back up. It will also give a store an option to add to the system as desired or financially able. This will also be good for minimal low cost entry with new technology. Advertising coupons can be instantly transmitted to the stores divider system computer for the customers to access. This is good for the customer and manufacturer. The manufacturer can find out how many customers and the location the coupons were used. This information can be received, processed and expedited much faster because it is electronic. Customers may even vote on their favorite food within the coupon menu display on the divider.

Charity donation data will be exchanged the same way. Accounts could be set up to help expedite donations. Because this is done electronically funds can be transferred promptly and more easley. Donation data can be accumulated on a particular region, store or divider. Organizations can place donations back into the region of origin. This will provide a service to a customer that does not presently exist and other donation prior art does not fully address to the extent of the transaction divider and system.

The divider and system computer will only relay information to a third party that the supermarket database permits and releases. The retail transaction divider addresses one or more of these methods and functions. Prior art also did not address a retail customer and product purchase divider with one or more of these functions. The divider will not use any more space at the supermarket POP that is not already used by the present plastic dividers. With every transaction divider acting as an individual unit data management, tracking, processing and channeling is possible. At this time prior art has not been found for a supermarket retail customer and purchase product divider with interactive electronic retail tasks and functions

### SUMMARY OF THE INVENTION

The main component variation of the retail transaction divider are with the LCD bar code scan capable display for exchanging data, and the wireless method that exchanges data with the divider systems computer. Also the touch keyboard and the touch screen display are a variation from one another. The size, shape, internal and external components, systems, programs, touch display configuration, power sources, menus, commands and functions can also vary because they may be designed and used for supermarkets specific needs.

The simplest version will incorporate a liquid crystal display (LCD) that will display any number of unique bar codes to be scanned by the POP scanner. On the touch key version the memory will be internal with a variation of wireless data exchange with a system computer. A number of pre-determined bar codes, that are stored in memory, are assigned to designate key selections on the divider. When a customer enters a selection on the touch keys the corresponding bar code will be displayed on the LCD. When the checker scans the bar code it is compared to a corresponding unique bar code stored in the store database computer and divider system computer. This will prompt the store database to send the purchase data to the register and receipt system. The LCD bar code variation allows a convenient way for the customer to perform a retail transaction because it will already be in their hand as a purchase product divider.

The other main variation is a divider with a touch menu display in place of a touch keyboard. This variation may contain a LCD bar code data transfer display or communicate data wirelessly. This variation may be used for electronic coupon redemption, advertising and charity donations. The LCD or wireless data transfer method, divider layout and commands of the touch menu display can very as to the supermarkets use. The main menu tasks are “on/clear”, store information, electronic coupon redemption, charity donations, self bar code scanning, check out, instructions and category totals. Sub menus for each main task will guide the customer through the process. The sub menus will have touch commands such as scroll, up, down, right, and left. Also other commands like enter, select, delete, back, forward, more, less, total, finish, other, A through Z, numbers and other commands for the supermarkets needs.

The most optioned variation will have a touch menu display, solar cell, battery and external charging capabilities, infrared or wireless data exchange, bar code scanner, store, bank and a credit card swipe system. External devices that will work in conjunction with the divider and system computer are digital weight scales and shopping cart pressure weight matt. These devices will transmit and receive data by a wireless or infrared method.

Any variation of the device may contain a solar power cell and battery for duel independent power. A third power source may consist of a remote charging base or POP divider placement-charging rail that is attached to the POP counter. The divider may have a notification indicator to notify the check out clerk that the customer has purchase data to be processed on the divider. Any variation will contain an internal individual identification serial number.

### DISCRIPTION OF DRAWINGS

FIG. 1 shows the point of purchase counter, divider in stand by in rail or charging rail, divider being used on conveyer, store computer data base, divider system computer, register, counter bar code scanner, hand held bar code scanner, infrared data port, wireless data transceiver for the dividers and outside communications link.

FIG. 2 shows a variation of the retail transaction divider with touch menu display, solar charging cell, check out notification indicator and LCD bar code display.

FIG. 3 shows a variation of the retail transaction divider with touch keyboard, solar charging cell, check output notification indicator and LCD bar code display.

FIG. 4 shows a variation of the retail transaction divider with touch menu display, check out notification indicator, solar charging cell, card reading swipe slot, infrared 2-way data port and bar code scanner window and base charging contacts.

FIG. 5 shows a variation of the main touch menu display layout, configuration and commands.

FIG. 6 shows a representation of a bar code tag to be self bar code scanned (FIG. 7).

FIG. 7 shows the divider in the proximity of the bar code (FIG. 6) that is to be scanned.

FIG. 8 shows an interactive weight scale and wireless data transceiver.

FIG. 9 shows a grocery cart sitting on a pressure sensitive weight scale matt and transceiver.

FIG. 10 shows a variation of a touch keypad and fixed commands.

FIG. 11 shows a variation of LCD bar code display and progression of sectional readout.

### DETAILED DESCRIPTION OF THE INVENTION

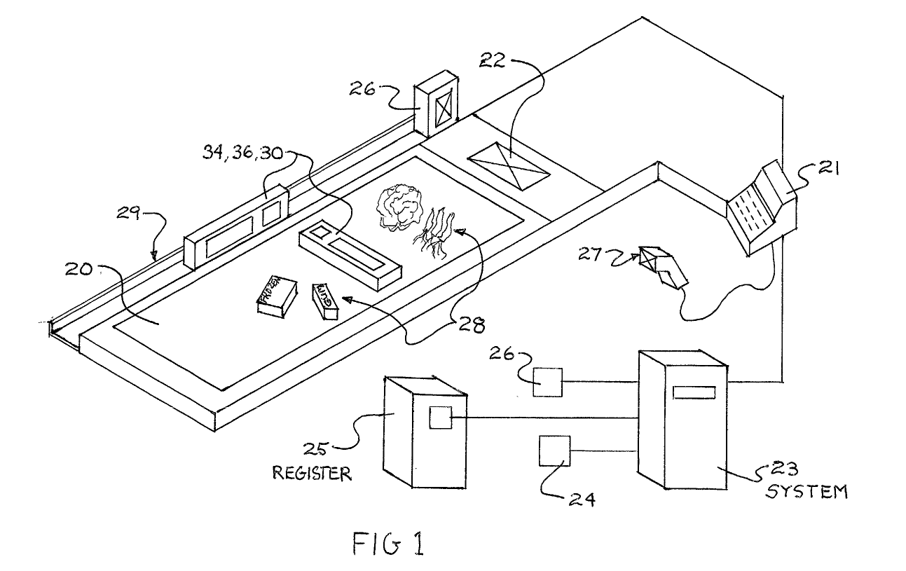

FIG. 1. Illustrates how the divider is used at the (point of purchase) POP counter. The divider 30, 34, 36 will sit in the standby rail 29 where the customer may pick it up or place it at the time of checkout The divider will be placed on the POP counter 20 between product purchases by the customer 28. One variation method of divider customer check out placement is if the store elects to use electronic check out placement. The customer will enter on the divider to check out 89. A number is electronically assigned to the customer and called up when it's their turn to complete the retail transaction. This method will eliminate the type of long and uneven grocery lines that are now common. In this case the divider also functions as a customer and purchased product placement divider as if it were placed on the POP counter. The variation with the LCD 67 bar code data transfer display will work in conjunction with the POP bar code scanner 22. The check out clerk will scan the LCD bar code 77 that will match the bar code with the store database 25. The LCD bar code may also be scanned with a hand held scanner 27. The transaction is reflected on the customer receipt printed by the register system 21.

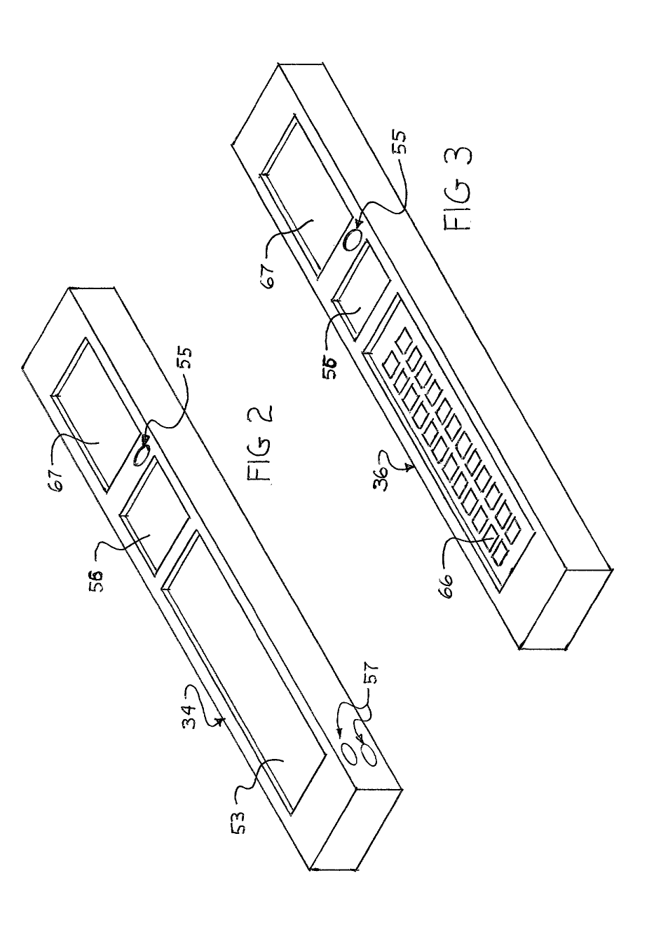

The LCD bar code display variation may contain a touch keyboard FIG. 3, 36 or a touch menu display FIG. 2, 34. The touch keyboard 66 will contain printed numbers or text for the key commands. It will also contain menu instructions and key prompts that are displayed on the LCD 67. When the customer chooses one or a combination of keys 66 the divider will recall a bar code either stored internally in the divider or on a dividers system computer. The scanned bar code is matched with the store database 25, product and price. The keys selected FIG. 10,—81, 82, 83 will appear on the LCD FIGS. 11—75. The LCD section 76—B is the menu driven instruction and prompt section. Section B frames are an example of the menu prompt commands. The LCD section 77 will display the bar code to be scanned by the check out clerk. LCD section 78 will contain electronic advertising that is stationary or moving. Touch keys 80 are function keys such as on, clear, scroll, and download. Numbered keys will be to enter a product and bar code to be displayed on the LCD. Keys with $ symbol 82 will be for monetary entry as part of the transaction. The LCD variation may also contain a touch menu display 53 in place of a touch keyboard. The touch menu display variation 53 will be able to access more menu options. This variation may use a wireless method of RF, infrared or microwave to exchange data with the divider system computer 23 or store data base computer 25. In a wireless variation data can be transmitted to the divider or from the divider depending on the stores need in a system.

Any variation may contain solar charging cells 56 to supplement battery power. Another power source may be an external charger with charging contacts 57 provided on the divider. A small external check out indicator 55 may be located on any variation to alert the check out clerk of a pending check out transaction. After the LCD bar code is scanned the checker will use the clear key 80F and place the divider for the next customer. The customer receives the transaction printed on a receipt.

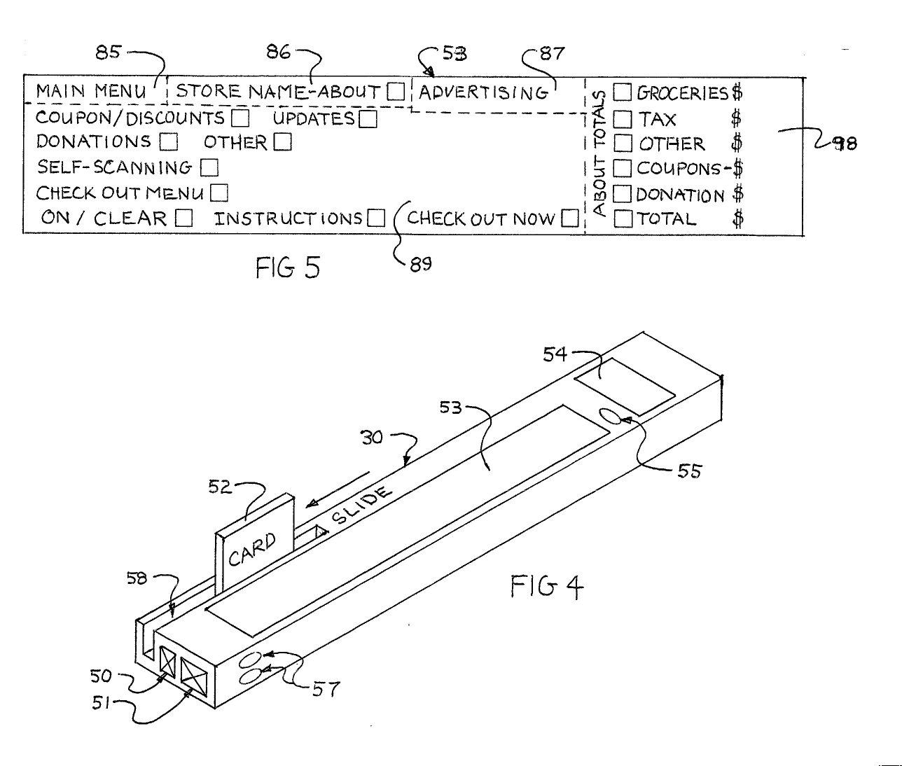

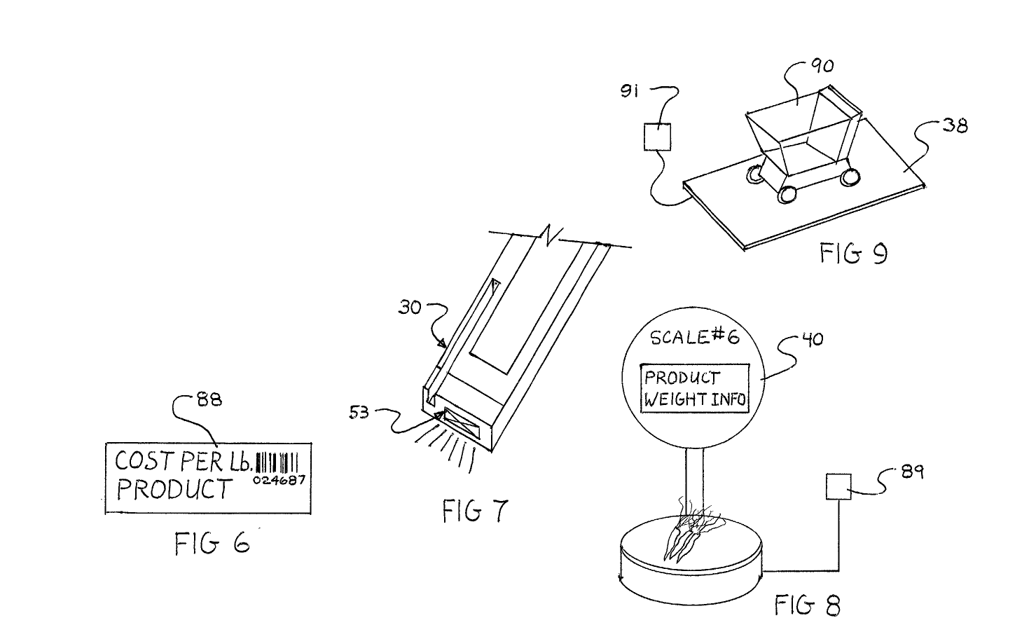

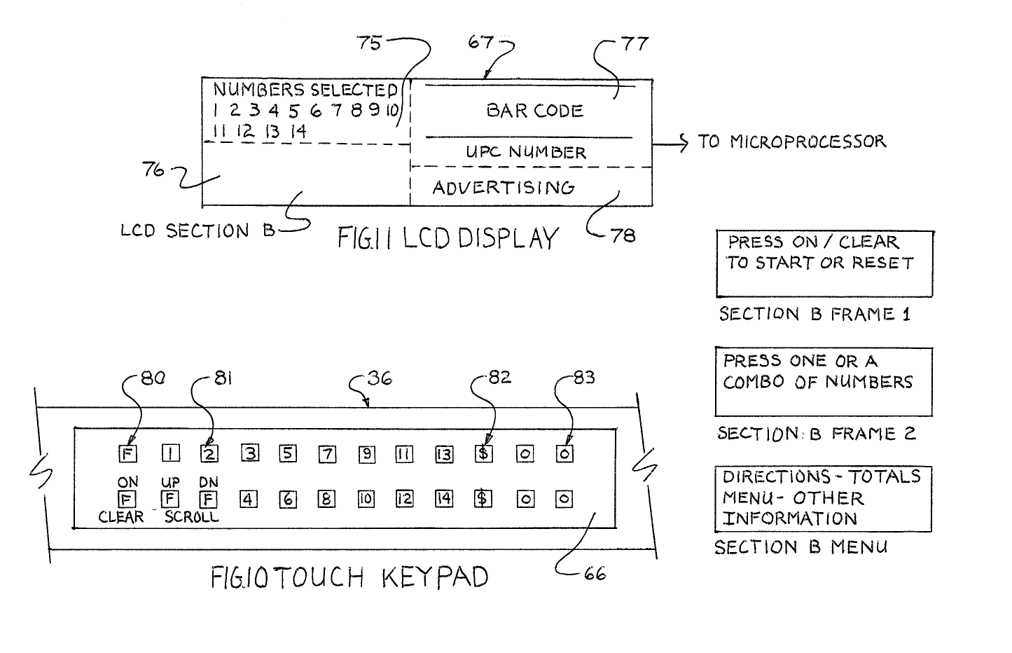

A variation of the most capable divider and system FIG. 4 will include a touch screen menu display 53, a solar cell 54 for system power and battery charging, a check out clerk notification indicator 55, a card swipe slot 58-52 for store, debit, credit or smart cards, an infrared data exchange port 50, an internal bar code scanner 51, battery charging contacts 57 for the internal battery, audio capabilities, video capabilities and wireless data transceiver. External components are a divider system computer 23 wireless data transceiver system 26 to communicate with the dividers as individual units, weight scales 40 and connecting transceiver 89 for data relay to the system computer transceiver 23, grocery cart weight scales 38 to weigh scanned products and cart 90 at check out and transceiver for the weight scale systems 89, 91 to relay data to the divider system computer. The retail tasks it will perform FIG. 5 (but not limited to) will be providing store information 86 and announcements, advertising 87 (still, scroll, audio, video), product updates 89 or announcements, electronic coupons 89 and product discounts, charity donations 89, product self bar code scanning 89, check out functions 89, totals of all the tasks 98 and touch menu area linking directly to any task menu.

The customer will access any one of the retail tasks on the touch menu 86. Sub menus in the tasks will direct the customer through the task. Commands may include scroll, enter, delete, search, letters A through Z, name search, select and others to complete the task. Each divider will contain memory and working software. Each divider will contain a unique identification number in the memory and is sent with all the divider data transmission. The divider system computer 23 will identify and separate all the data transmissions. This will allow the system computer 23 to search for the corresponding data in the store data base computer 25 and relay the purchase data to the particular divider. When the customer is done and the check out task is activated the divider system computer 23 will send the necessary transaction data to the store data, check out computer 25 and register 21.

When the customer accesses the menu task of coupons and discounts 89 the customer will be able to access and display electronic coupons by name or beginning letter. When the customer is finished with that task the total dollars and summary is displayed in the main menu totals area 98. The customer can access any task form the main menu totals area 98. If the customer is self-product scanning and scans a product that is in the coupon database the customer will be notified by way of the divider that an electronic discount coupon is available. By way of the about totals task 98 on the main menu the customer may go right to the coupon and select it to use and then go back to the on going scanning process. On the divider variation with infrared port or wireless data transmission system a central geographical location can access any divider system computer 23 via a outside communication hub 24 for telephone, intranet or satellite to delete, update, change or add coupons. Also the central location can learn what coupons were used, date, store location and divider number because every data exchange is tagged with the divider internal identification number.

When a customer accesses the charity donation menu 89 and donates funds, the total and summary will show on the main menu in the totals section 98. The customer will select a charity by name or first letter. Again the data can be changed by a one geographical location remotely in the way similar to the coupons. The charity donations can be tracked on a daily basis of how much, for what charity, store location, date and divider number.

When the customer is using the divider to self bar code scan product purchases they will access the menu and scan a product 88, 30. The self-scan menu can be navigated with scroll and touch screen commands on the touch display. By entering a weigh command and at the self-scan menu the customer can scan weight products. Upon scanning success the scanner may emit audio to inform the customer if the scan was successful. Then scanning the product bar code 88, 30 located by the product. When the product is placed on the scale the customer will enter the scale number 40 and the weight and purchase data will be entered in totals and purchase pending 98. During scanning the product, information and cost data will be displayed on the touch screen 53 for the customer to accept or decline. Purchases can later be edited by the check out clerk once the purchase completion is in progress at the POP FIG. 1. This will be done after all the transaction data has been transmitted to the store computer data base and register system 25.

When the customer enters “check out now” on the divider the divider system computer 23 in conjunction with the store data and register computer 25 compiles and sends the transaction data to the POP register 21 and divider display 98. The grocery cart 90 with the products is pushed onto a weight scale matt 38. The cart and every item in the store have had the exact weight entered into the divider system computer 23. To regulate against shrinkage the total weight of the cart 90 and product purchase 28 is compared with the scanned product data weight in the divider system computer 23 data weight for each item. The cart and products total weight and the matching data base totals for the scanned items should be the same weight. A store may prefer to have a checker bag the products and eye the products scan errors. Another store may want the customer to bag their groceries as they go leaving no need to empty and re-bag groceries.

A store, debit, credit or smart card 52 can be read and the processing data forwarded to the processing company. The product purchase data can be downloaded by an infrared data port 50 on the divider and located at the POP 26. The transaction divider 30 will keep the purchase and card data internally until transmitted to the store POP system and register 25, 21, the transaction is completed and then discard it. The other transaction divider version that is not wireless 36 will have internal memory, LCD that displays pre-stored bar codes 67 and an operating program. When finished the customer will receive a transaction receipt and the divider is cleared 80 and placed for the next customer.

What is claimed is:

1. An electronic retail product purchase and transaction divider comprising:
an exterior housing acting as a physical retail product purchase divider containing electronic data input component and visual display component coupled to generate, send and receive retail transaction data through a wireless method to or from a point of purchase system.

2. An electronic retail product purchase and transaction divider according to claim 1; wherein a data entry component exchanging input data with a retail point of purchase system containing product and price data and forwarding completed transaction data to a point of purchase register; and
a) a display showing input data, processed data and means of selection of data input.

3. An electronic retail product purchase and transaction divider according to claim 1; wherein wireless data exchange is executed upon data entry containing an attached device identification to a point of purchase register and accepts data to receive when identifying the device identification
a) an electronic identification number sent with data exchange to and from external communication devices attached to and defining transaction data.
